(19) United States
(12) Patent Application Publication
(10) Pub. No.: US 2026/0358472 A1
(43) Pub. Date: Nov. 12, 2026

(54) Method for calibrating a plurality of environment sensors of a vehicle, and calibration arrangement

(71) Applicant: AUMOVIO Autonomous Mobility Germany GmbH, Ingolstadt (DE)

(72) Inventors: David Schmitz, Wangen (DE); Jakob Schluttig, Lindau (DE)

(73) Assignee: AUMOVIO Autonomous Mobility Germany GmbH, Ingolstadt (DE)

(21) Appl. No.: 19/576,296

(22) Filed: Mar. 24, 2026

(30) Foreign Application Priority Data
May 6, 2025 (DE) 10 2025 117 286.2

(51) Int. Cl. G01S 7/40; G01S 13/72; G01S 13/931

(52) U.S. Cl. CPC G01S 7/4086; G01S 13/726; G01S 13/931; G01S 2013/9329

(57) ABSTRACT

A method for calibrating a plurality of environment sensors of arranged at different positions a vehicle. The environment sensors each have a field of vision, including a calibration position on which the vehicle is positioned, a plurality of calibration targets which are each arranged around the calibration position at a distance from the calibration position, such that at least one calibration target is present in each field of view. A respective setpoint position and setpoint orientation of the environment sensors on the vehicle and a setpoint position of the calibration targets are provided. At least one measurement is carried out. The environment sensors respectively determine the distance from the calibration target(s) within the respective field of view and the associated azimuth angle. The orientation of the vehicle on the calibration position is determined, and subsequently, the calibration of the environment sensors on the basis of the calibration targets is performed.

### CROSS-REFERENCE TO RELATED APPLICATIONS

This application claims priority under 35 U.S.C. § 120 to German Patent Application No. 10 2025 117 286.2 filed on May 6, 2025, the entire disclosure of which is incorporated by reference herein.

The present invention relates to a method for calibrating a plurality of environment sensors, in particular radar sensors, and to a calibration arrangement for a plurality of environment sensors, in particular radar sensors, in which the environment sensors are calibrated on the basis of a method according to the invention.

### BACKGROUND OF THE INVENTION

Modern means of transport, such as motor vehicles or motorcycles, are increasingly being equipped with driver assistance systems that, with the aid of sensor systems, are able to capture the environment, recognize traffic situations and assist the driver, for example by braking or steering intervention or by outputting an optical or acoustic warning. Radar sensors, lidar sensors, camera sensors or the like are normally used as sensor systems for detecting the environment. Insights about the environment can then be obtained from the sensor data determined by the sensors. The detection of the environment by means of radar sensors is based on the emission of bundled electromagnetic waves and the reflection thereof, e.g. by other road users, obstacles on the roadway or the buildings on the edge of the roadway. The detection of pedestrians is often carried out with camera sensors, but radar sensors are also increasingly being used in this respect.

The radar sensors used for systems of the type described above are also often used in combination with sensors based on other technologies, such as camera or lidar sensors. One of the advantages of radar sensors is that they operate reliably even in bad weather conditions and can measure not only the distance of objects but also their radial relative speed directly by way of the Doppler effect. Today, 24 GHz, 77 GHz, and 79 GHz are generally used as transmission frequencies. Owing to the increasing functional scope of such systems, the requirements, in particular with respect to the maximum detection range, are constantly increasing. In addition to the detection of the environment surrounding motor vehicles for systems of the type described above, the focus is now also including the interior monitoring of motor vehicles, e.g. detecting which seats in the vehicle are occupied; frequencies in the 60 GHz range, for example, are used here.

An important aspect of generic environment sensors is the calibration of these. For the end-of-line alignment or the calibration of a radar sensor at the end of the vehicle production line, calibration arrangements are generally used in which calibration targets are arranged around a vehicle. In this case, the vehicle has to be aligned very precisely with respect to the position and orientation of the calibration targets. Therefore, most car manufacturers use chassis dynamometers to align the vehicle horizontally. However, aligning the vehicle by means of chassis dynamometers is very complex and inflexible. In addition, a chassis dynamometer cannot be installed everywhere, as it usually requires a lot of space. Therefore, there is an increased interest in developing a method by way of which radar sensors in a vehicle are aligned or calibrated without first aligning the vehicle itself, and by way of which the space requirement can be reduced to a particular degree.

DE 10 2018 203 106 A1 incorporated herein by reference, discloses a sensor calibration device for adjusting sensors of a vehicle equipped with a driver assistance system, which comprises a vertical carrier arrangement to which a vertically adjustable and horizontally extending mounting rod is connected for the exchangeable reception of a plurality of vehicle-specific calibration panels to be arranged spaced apart from one another, wherein the horizontal mounting rod is connected to the carrier arrangement in a force-fitting manner via permanent magnetic fastening means.

Further, DE 10 2024 001 237 A1 incorporated herein by reference, discloses a method for calibrating radar sensors in a vehicle during production within a production line after the radar sensors have been installed and electrically contacted. In this case, a rectilinear relative movement takes place between the vehicle and radar-reflecting elements at constant speed, wherein the speed difference is used for automated calibration of the radar sensors. In this method, it must first of all be ensured that the positioning of the vehicle is exact, which positioning is also assumed to be fixed during the calibration. Errors in the alignment of the vehicle or in the position of the radar-reflecting elements can have a negative impact on the calibration here.

### SUMMARY OF THE INVENTION

Based on the prior art, an aspect of the present invention now consists in providing a calibration method or a calibration arrangement for environment sensors of a vehicle by means of which the calibration effort can be reduced in a simple and cost-effective manner.

In the method according to an aspect of the invention for calibrating a plurality of environment sensors of a vehicle, the environment sensors are arranged or mounted at different positions of the vehicle and each have a field of view in which they can capture surrounding objects or other road users, for example, but also calibration targets. Furthermore, a calibration position on which the vehicle is positioned is, wherein this positioning expressly does not have to be exact (i.e., the vehicle can be retracted to the calibration position in the measurement setup with tolerable deviations. Moreover, a plurality of calibration targets are provided, which are each arranged around the calibration position at a distance from the calibration position such that at least one calibration target is present in each field of view, wherein in each case a setpoint position (i.e., the installation location on the vehicle, e.g. rear left, rear right, rear center, front left, front right or front center, etc.) and setpoint orientation (i.e., precise installation for specifying the horizontal and vertical viewing directions of the sensor) of the environment sensors on the vehicle and a respective setpoint position of the calibration targets (i.e., where they are located spatially with respect to the calibration position, i.e., for example distance, angle, and/or height offset) is provided. This is followed by at least one measurement, in which the environment sensors respectively determine the distance from the calibration target(s) within the respective field of view and the associated azimuth angle, and on the basis of the determined distances and azimuth angles for each calibration target and the setpoint positions of the calibration targets and the setpoint positions and setpoint orientations of the environment sensors on the vehicle, the exact orientation of the vehicle at the calibration position is determined or calculated, and subsequently the environment sensors are calibrated on the basis of the calibration targets, taking into account the determined orientation of the vehicle. For example by determining in this case a misalignment error on the basis of the determined accurate orientation of the vehicle on the calibration position, possibly taking into account the information from the environment sensors (e.g. distance, azimuth angle) and the setpoint positions of the calibration targets as well as the setpoint positions and setpoint orientations of the environment sensors, by which the horizontal and/or vertical alignment of the respective environment sensor can then be corrected.

Preferably, the environment sensors are radar sensors and the calibration targets are radar targets, in particular metal posts, corner reflectors, triple mirrors, metal plates, and/or Doppler generators.

Expediently, the altitude angle of a calibration target can additionally be determined by the environment sensors during the measurement (for example, radar sensors are known which can determine an altitude angle), wherein the altitude angle is additionally used to determine the orientation of the vehicle to the calibration position.

According to an advantageous configuration of the method, if there are a plurality of calibration targets in a field of vision of an environment sensor, the distances between these calibration targets and this environment sensor may differ. As a result, it is easily possible to determine which calibration target is involved.

Expediently, at least two fields of vision of the environment sensors can overlap, such that overlap areas of the fields of view are present. However, it is expressly also possible for a plurality of fields of vision to overlap, such that overlap areas are also created that comprise fields of vision of two, three, or more sensors.

Preferably, a calibration target is arranged in at least one overlap area. Calibration targets in overlap areas are particularly well suited to the calculation since they are acquired by multiple environment sensors.

According to a particularly advantageous design of an aspect of the invention, the calibration position is situated on a conveying path, wherein the calibration targets are arranged on both sides along the conveying path and the vehicle is moved through the conveying path to the calibration position at preferably constant speed. This construction is particularly advantageous for the series production of vehicles, since this construction can be easily integrated into an existing production line (or manufacturing line or production line), wherein the conveying path then is part of the production line.

In this case, in a practical manner, a plurality of measurements can be carried out within a measuring time while the vehicle is moving through the conveying path or is moved through the measuring setup or the calibration arrangement on the basis of the conveying path, wherein each environment sensor in each case acquires and tracks the calibration targets in its field of vision during the measuring time (“tracking”; wherein spatial tracking of the calibration targets moved relative to the vehicle (but static) is carried out). The calibration position runs or shifts along with the movement path in this configuration, and/or the calibration position can also comprise a series of a plurality of secondary positions following one another in this design.

In accordance with a particular design of the method, the horizontal alignment of the environment sensors relative to the forward movement direction of the vehicle can be determined on the basis of the calibration targets tracked, wherein these are used to determine the orientation of the vehicle relative to the forward movement direction. Subsequently, the environment sensors can be calibrated on the basis of the calibration targets taking into account the determined orientation of the vehicle relative to the forward direction of movement, in particular by correcting the horizontal alignment of the respective environment sensor by a misalignment error that is determined on the basis of the known nominal alignment of the environment sensor and the alignment of the vehicle (relative to the forward direction of movement).

Incidentally or subordinately, an aspect of the present invention also comprises a calibration arrangement for a plurality of environment sensors, in particular radar sensors, of a vehicle, which are arranged or mounted at different positions of the vehicle and each have a field of vision. The calibration arrangement comprises at least one calibration position on which the vehicle is positioned, a plurality of calibration targets, in particular radar targets, which are each arranged at a distance from the calibration position around the calibration position, such that at least one calibration target is present in each field of view of an environment sensor, wherein the calibration arrangement is prepared to perform the calibration or alignment of the environment sensors on the basis of a method according to any one of the preceding claims.

By means of the calibration arrangement according to an aspect of the invention and the method according to an aspect of the invention, a conventional chassis dynamometer is advantageously no longer required. Furthermore, the vehicle does not need to be aligned exactly with the calibration position, since the orientation of the vehicle is determined on the basis of the method. In this way, a great deal of time can be saved in comparison with known methods. In addition, the calibration method is improved to a particular degree, since errors due to the manual orientation of the vehicle are avoided. The method according to an aspect of the invention and the calibration arrangement according to an aspect of the invention are provided in particular for the end-of-line calibration of environment sensors, in particular radar sensors, i.e. in order to carry out, optimize, correct, and/or check an alignment or adjustment of the environment sensors at the factory after mounting the environment sensors on the vehicle. Furthermore, the method/the calibration arrangement can also be used for sensor calibration after installation in the context of maintenance and repair measures.

### BRIEF DESCRIPTION OF THE DRAWINGS

An aspect of the invention is described in more detail below on the basis of advantageous exemplary embodiments. In particular:

FIG. 1 shows a simplified representation of a design of a static calibration arrangement according to an aspect of the invention, and

FIG. 2 shows a simplified representation of a design of a dynamic calibration arrangement according to an aspect of the invention.

### DETAILED DESCRIPTION OF EXEMPLARY EMBODIMENTS

The method according to an aspect of the invention and the calibration arrangement according to an aspect of the invention serve to calibrate or to align a plurality of environment sensors in a vehicle without the vehicle itself having to be precisely aligned beforehand. In this case, the calibration arrangement consists of a plurality of calibration targets which are positioned around the vehicle. The sensor structure of the vehicle as described below comprises a plurality of radar sensors with different installation positions and alignments as environment sensors. Accordingly, radar targets are provided as calibration targets.

The method is based in this case on the information gained by combining the data from all radar sensors, with each radar sensor providing the azimuth angle, (if possible or optionally) the altitude angle and the distance from the (area) of the calibration target. A distinction can be made between two main calibration setups: a steady-state calibration setup and a dynamic calibration setup.

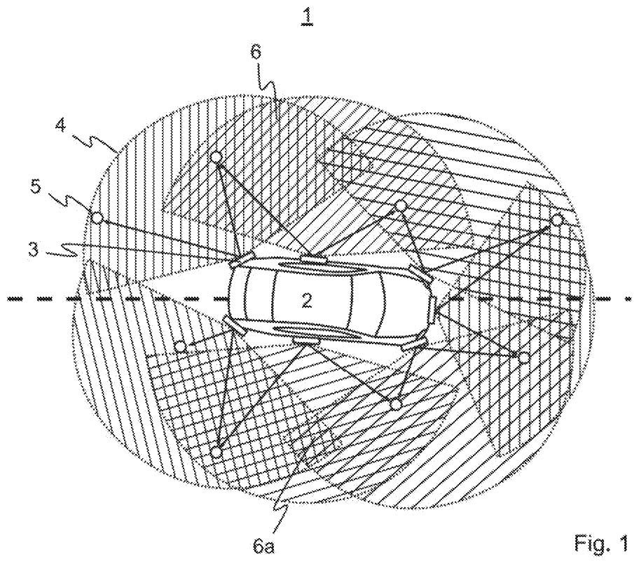

In the static calibration setup or calibration arrangement 1, a plurality of radar targets 5 are placed or arranged around the expected position of the vehicle 2, which comprises a plurality of radar sensors 3, each with its own field of view 4, as illustrated in FIG. 1. The positions of the radar targets 5 are selected such that at least one radar target 5 is present in the field of view 4 of each radar sensor 3. Furthermore, the radar targets 5 must be distinguishable by their distance if multiple radar targets 5 are in the field of vision 4 of a radar sensor 3. Furthermore, the fields of vision 4 of the radar sensors 3 can also overlap in overlap areas 6, wherein more than two fields of vision 4 can also overlap in an overlap area 6a. For the positioning or arrangement of the radar targets 5, positions in the overlap areas (in particular of two fields of view 4) may then be preferred.

The vehicle 2 is placed in the center or in the region between multiple radar targets 5 in this case. Each radar sensor has a specific field of view 4, which is indicated in FIG. 1 by a sector of a circle. In FIG. 1, each radar sensor 2 has at least two radar targets 5 in its field of view 4, this not being absolutely necessary, however. The vehicle 2 is positioned in a rotated manner with respect to the calibration station, which is indicated by the dashed horizontal line. Accordingly, it is not exactly aligned, but rather merely retracted “approximately straight” into the calibration arrangement.

The radar targets 5 are metal posts, corner reflectors, metal plates, or Doppler generators. The vehicle 2 and the radar targets 5 are not moving, i.e., the scene is stationary during the measurement. Since the vehicle 2 was not exactly placed (i.e., not exactly aligned in the measurement stand or within the calibration arrangement), the exact positions and alignments of the radar sensors 3 relative to the radar targets 5 are not known. Nevertheless, the nominal position and alignment of the radar sensors 3 relative to the vehicle 2 are known. The position of the radar targets 5 in world coordinates is also known. In a first step, each individual radar sensor 3 then measures the distances or distances with respect to the radar targets 5 in its field of view 4. The same measurement provides the azimuth angle at which the radar sensor 3 detects the radar target 5. This results in a series of distances and azimuth angles which are transmitted to a central processing unit or control unit. An optimization algorithm then determines the position and the alignment of the vehicle 2 on the basis of the measured distances and azimuth angles. It therefore comprises the measured distances or distances and angles of the radar targets 5, which are provided by the various radar sensors 3. In addition, the algorithm uses the knowledge about the setpoint position and orientation of the radar sensors 3 as well as the setpoint position of the radar targets 5. The calculation in this case yields the position and alignment of the vehicle 2 relative to the radar targets 5. A simple comparison of the angle measurement and an angle to be expected from the measurement setup makes it possible here to determine the horizontal misalignment.

The optimization algorithm compares the expected angles and distances of the individual environment sensors for all possible orientations and positions of the vehicle 2 within defined limits and predefined step widths with the measured angles and distances. A cost function, for example a weighted standard, describes the overlap and can be used for minimum determination. The expected angles and distances of the individual environment sensors for all possible orientations and positions of the vehicle within defined limits and predefined step widths can be precalculated and provided for a production line and vehicle type. This reduces the computational complexity to a particular extent. Even though the search range is usually not particularly large and the calculation of the cost function can be kept simple, further optimization measures can be applied, such as gradient methods or a genetic algorithm. A combination of a sparsely populated search grid and one of the advanced optimization methods mentioned above can also be used.

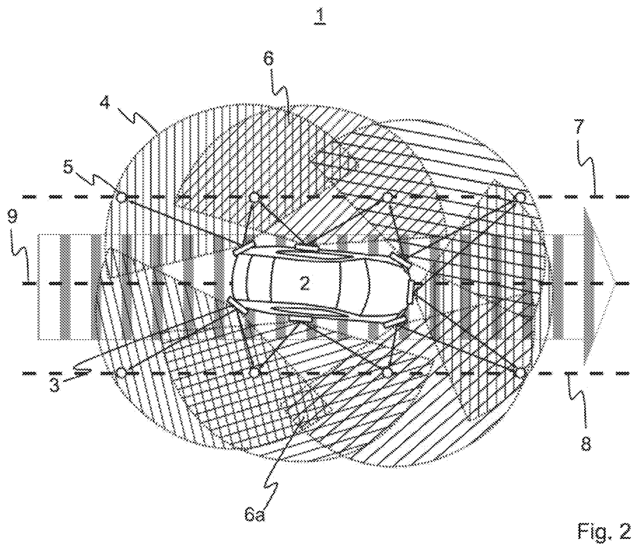

A design of a dynamic calibration setup or calibration arrangement is illustrated in FIG. 2. This arrangement is similar to a usual situation in automobile production, in which the vehicle 2 moves from left to right on a conveying path (indicated by the striped thick arrow). Here, too, the exact position and alignment of the vehicle 2 on the conveying path is unknown. The vehicle 2 moves slowly along a series of radar targets 5. The radar targets 5 are positioned such that they can be separated from one another in view of the detected distance or the distance or the Doppler of the radar signal. Here, the radar targets are designed, for example, as metallic posts which have an appropriate reflectivity in all directions and are located on both sides of the conveying path. They are at the same/constant distance from one another. Furthermore, the distance from the center of the conveying path is identical for all radar targets 5. Each radar sensor 3 has a specific field of view 4, which is indicated in FIG. 2 by a sector of a circle. Each radar sensor 3 tracks the radar targets 5 that are located in its field of view 4. Here, the vehicle may also be rotated in relation to the forward movement direction of the conveying path.

Unlike static calibration, dynamic calibration is dependent not on a single measurement, but on a series of measurements while the vehicle 2 is moving. Each individual radar sensor 5 tracks the targets in its field of view 4 during the entire measuring time. At the end of the measuring setup, each individual radar sensor 3 assesses its horizontal alignment relative to the forward direction of movement on the basis of the tracked radar targets 5. This is done simply by evaluating the lateral object position over the entire track. All the radar sensors 3 supply this information to a central unit or a central control unit, where the information is used to calculate the orientation of the vehicle 2 relative to the forward direction of travel. In a final step, the horizontal alignment of the sensor is corrected by the nominal alignment and the alignment of the vehicle 2, which gives rise to the horizontal offset value.

In contrast to the static calibration method, the information content is smaller in the case of dynamic calibration. Due to the moving design, the position of the radar targets 5 is not known. What is known, however, is the distance between the two target lines 7, 8, along which the radar targets 5 are preferably arranged on both sides, i.e. to the left and right of the conveying path, so that all the radar targets 5 are at the same lateral distance from the movement center line 9 (otherwise the information about the lateral distance would be difficult to use efficiently). The optimization grid therefore extends only over the lateral offset of the vehicle in relation to the center line 9 and the horizontal rotation of the vehicle 2. In contrast, in the static method, the optimization grid also spans over the longitudinal offset.

In both static and dynamic calibration, there is the risk of ambiguity if only the mere measured target angles are used. If, for example, all the environment sensors are rotated horizontally in one direction, the algorithm may not be able to decide on the basis of the mere angle information whether it is a rotation of all the radar sensors 3 in the same direction or a rotation of the vehicle 2 in this very direction. To resolve the ambiguity, the target distances are considered. A comparison of the lateral target distances at the front and rear, or right and left, provides a further indication of the horizontal vehicle alignment and can be used for plausibility checking.

In summary, an important aspect of the present invention is the calibration of the environment sensors without the exact alignment of the vehicle 2 in the measurement stand, although this exact alignment is essential for known calibration methods. Therefore, in the calibration method presented here, the vehicle orientation or the vehicle position is determined. As a result, the actual calibration (according to known scales) can then be performed. The novel determination of the orientation of the vehicle using the environment sensors present in the vehicle advantageously makes it possible to dispense with exact orientation of the vehicle to the calibration position, with the result that the calibration effort can be reduced in a surprisingly simple and cost-effective manner compared to known methods.

### LIST OF REFERENCE NUMERALS

1 calibration arrangement
2 vehicle
3 radar sensor
4 field of view
5 radar target
6 overlap area (between two sensors)
6a overlap area (among three sensors)
7 target line
8 target line
9 center line

1. A method for calibrating a plurality of environment sensors of a vehicle, wherein the environment sensors are arranged at different positions of the vehicle and each have a field of vision, the method comprising:
a calibration position on which the vehicle is positioned,
a plurality of calibration targets, which are each arranged at a distance from the calibration position around the calibration position, such that
at least one calibration target is present in each field of view wherein
in each case a respective setpoint position and setpoint orientation of the environment sensors on the vehicle and a setpoint position of the calibration targets is provided,
at least one measurement is carried out, wherein the environment sensors respectively determine the distance to the calibration target(s) within the respective field of view and the associated azimuth angle, and
on the basis of the determined distances and azimuth angles for each calibration target and the setpoint positions of the calibration targets and the setpoint positions and setpoint orientation of the environment sensors on the vehicle, the orientation of the vehicle at the calibration position is determined, and
subsequently, the environment sensors are calibrated on the basis of the calibration targets, taking into account the determined orientation of the vehicle.

2. The method as claimed in claim 1, wherein the environment sensors are radar sensors and the calibration targets are radar targets, in particular metal posts, triple mirrors, corner reflectors, metal plates, and/or Doppler generators.

3. The method as claimed in claim 1, wherein, during the measurement, the altitude angle of a calibration target is additionally determined by the environment sensors and the altitude angle is additionally used to determine the orientation of the vehicle on the calibration position.

4. The method as claimed in claim 1, wherein if there are multiple calibration targets in a field of view of an environment sensor, the distances between these calibration targets and this environment sensor differ.

5. The method as claimed in claim 1, wherein at least two fields of vision of the environment sensors overlap such that overlap areas of the fields of view are present.

6. The method as claimed in claim 5, wherein a calibration target is arranged in at least one overlap area.

7. The method as claimed in claim 1, wherein the calibration position is situated on a conveying path, wherein the calibration targets are arranged on both sides along the conveying path and the vehicle is moved through the conveying path to the calibration position.

8. The method as claimed in claim 7, wherein a plurality of measurements are taken within a measuring time while the vehicle is moving through the conveying path, wherein each environment sensor detects and tracks the calibration targets in its field of view during the measuring time.

9. The method as claimed in claim 8, wherein the horizontal alignment of the environment sensors relative to the forward direction of movement of the vehicle is determined on the basis of the tracked calibration targets and these are used to determine the orientation of the vehicle relative to the forward direction of movement and subsequently the calibration of the environment sensors on the basis of the calibration targets, taking into account the determined orientation of the vehicle relative to the forward direction of movement.

10. A calibration arrangement for a plurality of environment sensors, in particular radar sensors, of wherein the environment sensors are arranged at different positions of the vehicle and each have a field of vision comprising a calibration position on which the vehicle is positioned,
a plurality of calibration targets, in particular, radar targets, which are each arranged at a distance from the calibration position around the calibration position, such that
at least one calibration target is present in each field of view, wherein
the environment sensors are calibrated on the basis of a method as claimed in claim 1.

11. The method as claimed in claim 2, wherein, during the measurement, the altitude angle of a calibration target is additionally determined by the environment sensors and the altitude angle is additionally used to determine the orientation of the vehicle on the calibration position.
